(19) United States
(12) Patent Application Publication
(10) Pub. No.: US 2020/0305477 A1
(43) Pub. Date: Oct. 1, 2020

(54) EGG-FREE ALBUMEN REPLACEMENT

(71) Applicant: MANTROSE-HAEUSER CO., INC., Westport, CT (US)

(72) Inventor: Mingwei Wang, Lemont, IL (US)

(73) Assignee: MANTROSE-HAEUSER CO., INC., WESTPORT, CT (US)

(21) Appl. No.: 16/829,136

(22) Filed: Mar. 25, 2020

Related U.S. Application Data
(60) Provisional application No. 62/823,877, filed on Mar. 26, 2019.

(51) Int. Cl. A23L 15/00

(52) U.S. Cl. CPC A23L 15/35

(57) ABSTRACT

An egg-free albumen replacement includes a starch, an edible gum and a hydrolyzed pea protein. The egg-free albumen replacement can include the hydrolyzed pea protein in an amount of 3 to 75 wt. %, based on the combined weights of the starch, edible gum and hydrolyzed pea protein in the replacement composition. At least some of the hydrolyzed pea protein in the egg-free albumen replacement can include partially hydrolyzed pea protein.

### CROSS-REFERENCE TO RELATED APPLICATION

This application claims priority to and all benefit of U.S. Provisional Patent Application Ser. No. 62/823,877, filed on Mar. 26, 2019 and entitled EGG-FREE ALBUMEN REPLACEMENT, the entire disclosure of which is incorporated herein by reference.

### BACKGROUND OF THE INVENTION

A “traditional” or “natural” meringue is a type of dessert or candy, often associated with French, Spanish, Swiss and Italian cuisine. It is made from whipped egg whites (hen egg albumen), sugar, and optionally an acidic ingredient such as lemon, vinegar, or cream of tartar. A binding agent such as salt, corn starch or gelatin can also be included.

Many other food products are also made with egg albumen, examples of which include cookies, cakes, breads, pastas, frostings, other gluten-free baked products, chewy candies, various different beverages including mochas, milk shakes, chocolate milk, buttermilk and eggnog, for example, ice cream, sherbet, sorbets, etc.

As well understood in the art, egg albumen is formed from a variety of different proteins which, in combination, contribute to its important functional properties including solubility, ability to emulsify, foam formation and gel formation.

Plant-based products have found a significant market in recent years with potential for further significant growth. Beyond ongoing technical development, reasons for this include sustainability, heath consciousness, plant-based lifestyles and unavailability of eggs.

A wide variety of egg replacement products are known and available to consumers. For example, bananas, apple sauce, prunes, pumpkin, flax, chia, nuts, and garbanzos have been long used as whole egg replacements. They work well in some types of foods, but they do not work well or at all in foods which are based on or contain delicate whipped albumen such as meringues. See, for example, Abu-Ghoush et al., Comparative Study of Egg White Protein and Egg Alternatives Used in Angel Fook Cake Systems, Journal of Food Processing and Preservation, Vol. 34, pp 411-425, published 2010, which indicates that, except for whey protein isolate, the many different protein sources tested were incapable of providing a suitable whipped albumen substitute for use in making angel food cakes.

Recently, egg-free albumen replacements for making delicate whipped albumen foods such as meringues have become known. One is based on chickpea broth, which is also known as aquafaba. Unfortunately, meringues made from aquafaba exhibit poor storage stability as well as poor freeze-thaw characteristics. In addition, these meringues cannot be stored and supplied in the form of dry powders to be reconstituted with water, because these reconstituted powders will not whip adequately.

Another recently developed egg-free albumen replacement for making delicate whipped albumen foods is made from saponin-rich plants. See, WO 2013/022750A9. As described there, meringues made from this albumen replacement can be stored and supplied in the form of a dry powder to be reconstituted with water. However, saponin extract is not a commonly recognizable or readily available. In addition, saponin-based meringues tend to have a disagreeable aftertaste.

### SUMMARY OF THE INVENTION

In accordance with this invention, it has been found that, by adding a small but suitable amount of a partially hydrolyzed pea protein to a mixture of starch and a naturally-occurring gum, an egg-free albumen replacement can be produced which, when combined with water, produces an egg-free albumen substitute exhibiting all of the desirable functional properties needed to make a high-quality meringue with no undesirable aftertaste.

Accordingly, this invention provides an egg-free albumen replacement comprising starch, an edible gum and a hydrolyzed pea protein in an amount of 3 to 75 wt. %, based on the combined weights of all of the starch, edible gum and hydrolyzed pea protein in the composition.

In addition, this invention also provides a liquid egg-free albumen substitute comprising the above egg-free albumen replacement plus enough water or other aqueous liquid to transform this albumen replacement into a liquid composition resembling naturally occurring hen egg albumen.

In addition, this invention also provides a dry powder mix for forming into a final food product, the dry powder mix comprising the above egg-free albumen replacement plus one or more food additives.

In addition, this invention further provides a dry powder mix capable of forming an egg-free meringue when combined with water and whipped, this powder composition comprising sugar and the above egg-free albumen replacement.

Finally, this invention also provides a food product which comprises the material obtained by combining at least one of flour, sugar, one or more other flavoring agents and an optional aqueous liquid with the above egg-free albumen replacement followed by processing the mixture so formed into the food product by one or more of mixing, beating, whipping, baking, chilling and freezing.

### DETAILED DESCRIPTION

### Definitions

For the purposes of this disclosure, the following terms will have the following meanings:

“Albumen” unless otherwise indicated means hen egg albumen.

“Albumen replacement” refers to compositions of this invention which are composed of starch, gum and hydrolyzed pea protein and which contain no intentionally added water or other aqueous liquid, while “albumen substitute” refers to such compositions which contain enough intentionally added water or other aqueous liquid to form a liquid resembling naturally-occurring albumen.

“Appropriate processing” as it relates to making an ultimate food product from the albumen replacement of this invention refers to the type of processing normally used to make that type of ultimate food product, examples of which include one or more of mixing, beating, whipping, baking, chilling and freezing. For example, if the ultimate food product being made is a meringue, then appropriate processing would refer to the processing normally used to make conventional meringues, i.e., whipping followed by optional baking depending on the type of meringue being made. Similarly, if the ultimate food product being made is a cookie or cake, then appropriate processing would refer to the processing normally used to make cookies and cakes, i.e., combining with additional ingredients such as nuts and chocolate chips followed by mixing and then baking.

“Dry powder” means a particulate mass which contains no intentionally added water or other aqueous liquid and further which is capable of flowing as a result of gravity. A particulate mass in which the particles have agglomerated into clumps will also be regarded as a dry powder provided that the clumps can be broken up by hand.

“Egg-free” means that no amount of a fowl egg, or any component thereof, has been intentionally added to the composition being referred to.

“Flavoring agent” means an edible material which is used in food preparation primarily to improve the flavor of the food product being made, examples of which include natural and synthetic sweeteners such as cane sugar, spices such as nutmeg and cinnamon, fruit and berry products such as peaches, apples, blueberries raspberries, jams and jellies made from these fruit and berry products, orange and lemon zests, extracts such as vanilla bean extract, various liquids such as lemon juice, orange juice and vinegar, and the like.

Starch

The egg-free albumen replacement of this invention comprises starch, an edible gum and hydrolyzed pea protein.

The starch component of the inventive egg-free albumen replacement can be derived from any type of plant including, but not limited to plants commonly used as starch sources such as maize (corn), rice, wheat, potatoes and cassava as well as less common plants such as acorns, arrowroot, arracacha, bananas, barley, breadfruit, buckwheat, canna, colacasia, katakuri, kudzu, malanga, millet, oats, oca, Polynesian arrowroot, sago, sorghum, sweet potatoes, rye, taro, chestnuts, water chestnuts and yams, and many kinds of beans such as favas, lentils, mung beans. Starch derived from peas and chickpeas can also be used. Mixtures of these different starches can also be used. Gluten-free starches such as pea starch are desirable when the ultimate food product to be made is gluten-free.

Although these starches can be modified by chemicals and/or enzymes, and although these starches can be pregelatinized such as by the application of heat, it has been found that unmodified starches, i.e., “native” starches, work the best in this invention. That being the case, it is desirable that at least 50 wt. %, at least 85 wt. % or even at least 90 wt. % of the starch component of the inventive egg-free albumen replacement be composed of native starch. Native corn starch, native rice starch, native potato starch and native pea starch are preferred.

### Edible Gum

The second ingredient of the inventive albumen replacement is an edible gum.

Edible gums are commonly used in many different types of food products as thickeners and stabilizers. Examples include xanthan gum, locust bean gum, guar gum, gum acacia, ghatti gum, Psyllium seed gum, gellan gum and gum Tragacanth. Any of these edible gums can be used to make the albumen replacement of this invention. Mixtures of these edible gums can also be used.

Preferred edible gums are xanthan gum, locust bean gum and guar gum. Mixtures of xanthan gum and locust bean gum are more preferred, especially those in which the xanthan/locust bean gum weight ratio is 4:1 to 0.75:1, 3:1 to 1:1, 2.5:1 to 1.1:1 or even 2:1 to 1.25:1. Mixtures of all three of these gums are especially preferred, especially those in which the xanthan/locust bean gum weight ratio is the same as set forth above and the amount of guar gum included in the mixture is 1-15 wt. %, more typically 2-10 wt. % or even 3-5 wt. %, based on the total amount of edible gum present.

Mixtures of xanthan gum and locust bean gum, and especially mixtures of xanthan gum, locust bean gum and guar gum, are especially preferred, since it has been found that the performance shelf lives of meringues made with these mixtures (i.e., their resistance against collapsing) can be extended after freezing.

### Pea Protein

The third ingredient of the inventive albumen replacement is partially hydrolyzed pea protein.

“Raw” or “native” (unmodified) pea protein is obtained by extraction from yellow peas (Pisum sativum, L.). Normally it is obtained in the form of a protein concentrate containing 30 to <90 wt. % protein or an isolate containing ≥90 wt. % protein.

It is common practice in industry to hydrolyze native pea protein to modify its properties. This can be done chemically by contact with a suitable acid or base, e.g., HCl or NaOH, or by contact with a suitable enzyme. This causes the peptide bonds in the protein molecule to be cleaved, thereby separating it into smaller segments. The extent to which this occurs is commonly known as the “degree of hydrolysis” or “DH” of the protein hydrolysate obtained. Technically, degree of hydrolysis (DH) is defined as the proportion of cleaved peptide bonds in a protein hydrolysate relative to the total amount of peptide bonds in the protein before hydrolysis occurred.

The functional properties of pea protein such as solubility in water and its ability to act as an emulsifier, foaming agent and a gelling/coagulation agent can be improved significantly by hydrolysis. As known in the art, these property improvements generally occur when the extent of protein hydrolysis is between about 1% and 10% in terms of DH, depending on a number of factors including the particular native pea protein and hydrolysis treatment used. If hydrolysis occurs to a greater extent, then these functional properties may actually diminish relative to the native pea protein being hydrolyzed. See, Barac et al., Functional Properties of Pea (Pisum sativus, L.) Protein Isolates Modified with Chymosin, Int. J. Mol. Sci, Vol. 12, pp. 8372-8387, publish 2011.

Although unhydrolyzed pea protein is available, most pea protein sold commercially has been hydrolyzed at least to some degree. A majority has been hydrolyzed by an extent sufficient to improve one or more of the above functional properties, typically by about 1%-10% in terms of DH.

Interestingly, these partially hydrolyzed pea proteins are normally sold and referred to in commerce simply as “pea protein,” even though some intentional hydrolysis has occurred. For the sake of clarity, however, in this disclosure, these pea proteins are referred to as being “partially hydrolyzed.” More specifically, pea proteins which have been hydrolyzed to the extent that at least one of the above functional properties (i.e., solubility, emulsifying capability, foaming capability and gelling capability) is improved without making the other of these functional properties worse are referred to in this disclosure as being “partially hydrolyzed.” Thus, the degree of hydrolysis (DH) of the partially hydrolyzed pea proteins used in this invention will typically be ≥1%, ≥2%, ≥3%, ≥4%, ≥5%, or even ≥6% and, in addition, <10%, ≤9%, ≤8%, ≤7%, ≤6%, ≤5%, or even ≤4%.

Also sold commercially are pea proteins which have been hydrolyzed by an extent such that at least one of the above function properties has been made worse relative to the native protein from which it is made, typically to a DH of more than 10%. That is to say, hydrolysis has continued past the point where this functional property has improved and proceeded further to the extent that this functional property has actually been made worse relative to the native protein. See, page 8373 of the above-noted Barac et al. publication.

Interestingly, these pea proteins are normally sold and referred to in commerce simply as “hydrolyzed pea protein.” However, for the sake of clarity, in this disclosure, these pea proteins are referred to as being “fully hydrolyzed” or “intensively hydrolyzed.” More specifically, pea proteins which have been hydrolyzed to the extent that at least one of the above functional properties, after initially improving, is worse relative to the native starch from which it is made are referred to in this disclosure as being “fully hydrolyzed.” Thus, the degree of hydrolysis (DH) of the fully hydrolyzed pea proteins used in this invention will typically be ≥10%, ≥11%, ≥12%, ≥13%, ≥14%, or even ≥15%.

In accordance with this invention, it has been found that by combining a small but suitable amount of a partially hydrolyzed pea protein with the starch and gum ingredients described above, it is possible to develop an albumen replacement which when combined with water produces an egg-free albumen substitute exhibiting a desirable combination of functional properties mimicking naturally-occurring hen egg albumen. For example, it has been found that this albumen substitute, when combined with sugar and water and then whipped, will produce a high-quality egg-free meringue mimicking naturally-occurring meringue in terms of its light and delicate texture, firmness and body, and other organoleptic properties such as taste, texture, odor, color and mouthfeel. In addition, it has been further found that egg-free meringues made in this way actually exhibit even better storage stability and freeze-thaw resistance than their naturally-occurring counterpart. Finally, it has also been found that this albumen replacement not only can be formulated, stored and shipped in the form of a dry powder, but in addition can also be combined with other ingredients such as sugar, flavoring agents, leavening agents and the like thereby forming dry powder mixes that can also be stored and shipped in this form and then converted into ultimate food products by combining with water or other edible aqueous liquid and then processing in the normal way.

In a preferred embodiment of this invention, the inventive albumen replacement is made from a combination of at least two different hydrolyzed pea proteins, one or more but not all of which may be fully hydrolyzed. In other words, at least one of the hydrolyzed pea proteins in the inventive albumen replacement must be partially hydrolyzed. In various embodiments, the hydrolyzed pea protein of the inventive albumen replacement can include a first pea protein component and a second pea protein component. In various embodiments, the first pea protein component comprises partially hydrolyzed pea protein and the second pea protein component comprises fully hydrolyzed pea protein.

In this regard, meringues are normally made by whipping, i.e., beating or otherwise mechanically working the mixture of ingredients forming the meringue vigorously enough to incorporate air into the mixture, thereby forming a foamy or frothy mass. High quality meringues are both light, delicate and fluffy while simultaneously having sufficient “body” or “firmness” to hold together for an extended period of time. In contrast, some less-desirable meringues are too “thin” in the sense of being light, delicate and easily made but having insufficient body. Conversely, other less desirable meringues are too “thick” in the sense that they are undesirably heavy and are difficult to form even by vigorous whipping.

It will therefore be seen that there is an inherent trade-off in connection with making high quality meringues. Lighter meringues may be desirably delicate and easily made by simple whipping but have insufficient body to hold together for any length of time. Conversely, heavier meringues which have sufficient body and firmness are often undesirably dense and difficult to make even with vigorous mixing.

In accordance with this preferred embodiment, it has been found that the efficacy of a hydrolyzed pea protein when used in this invention in terms of its ability to produce a “light” or a “heavy” meringue depends, at least to some degree, on the extent to which this pea protein has been hydrolyzed. In particular, it has been found that pea proteins which have been hydrolyzed to a lesser extent tend to form “heavier” meringues when used in this invention, while pea proteins which have been hydrolyzed to a greater extent tend to form “lighter” meringues.

In accordance with this invention, this recognition is taken advantage of by using a combination of two or more different hydrolyzed pea proteins to make the egg-free albumen replacement of this invention, at least one of these hydrolyzed pea proteins having a lesser degree of hydrolysis and at least another of these hydrolyzed pea proteins having a greater degree of hydrolysis. In accordance with this preferred embodiment, the hydrolyzed pea protein with the lesser degree of hydrolysis is selected to ensure that the meringues obtained exhibit sufficient body, firmness, strength and stability, while the hydrolyzed pea protein with the greater degree of hydrolysis is selected to ensure that these meringues are desirably light and delicate and can be made with a relative ease by simple whipping.

When practicing this preferred embodiment in which two or more hydrolyzed pea proteins are used, all of these hydrolyzed pea proteins can be partially hydrolyzed, if desired. In other words, the combination of hydrolyzed pea proteins used can be formed only from partially hydrolyzed pea proteins. Alternatively, some but not all of the hydrolyzed pea proteins used can be fully hydrolyzed, if desired.

In both cases, it is desirable that the different hydrolyzed pea proteins used differ from one another in terms of their relative degrees of hydration (DH) by at least 2 percentage points, preferably at least 4 percentage points, at least 6 percentage points, at least 7 percentage points or even at least 8 percentage points to help ensure that all of the desired functional properties are achieved in the inventive egg albumen substitute. Thus, if only two hydrolyzed pea proteins are used, the DH of the more hydrolyzed pea protein should be ≥2 percentage points higher than the DH of the less hydrolyzed pea protein. Preferably, the DH of the more hydrolyzed pea protein will be ≥4, ≥6, ≥7 or even ≥8 percentage points higher than the DH of the less hydrolyzed pea protein.

On the other hand, if three or more hydrolyzed pea proteins are used, the average DH of the more hydrolyzed proteins should be ≥2, and preferably ≥4, ≥6, ≥7 or even ≥8 percentage points higher than the average DH of the less hydrolyzed pea protein. In other words, after dividing the total amount of hydrolyzed proteins present into two portions of equal weight, the average DH of the portion having the greater DH should differ from the average DH of the portion having the lesser DH by these percentage points.

Also, in this embodiment in which two or more hydrolyzed pea proteins are used, the relative amounts of the different hydrolyzed pea proteins used will depend on a variety of different factors such as the types of hydrolyzed pea proteins used and the degrees of hydrolysis (DH) of each of these pea proteins. For example, in those instances in which the DH of the more hydrolyzed pea protein approaches or exceeds 10%, e.g., ≥8%, ≥9%, ≥11%, or even ≥12%, the amount of this more hydrolyzed pea protein used will generally be less than the total amount of the less hydrolyzed pea proteins used. And this is especially so if the average DH of the more hydrolyzed protein is ≥4, ≥6, ≥7 or even ≥8 percentage points higher than the average DH of the less hydrolyzed pea protein.

In these instances, the amount of the more hydrolyzed pea protein used will generally be ≤60 wt. %, ≤50 wt. %, ≤40 wt. %, ≤30 wt. %, ≤20 wt. %, ≤15 wt. %, ≤10 wt. % or even ≤5 wt. %, of the total amount of hydrolyzed pea proteins used. In contrast, in those instances in which the DH of the more hydrolyzed pea protein is lower, e.g., ≤8%, ≤7% or even ≤6%, the amount of the more hydrolyzed pea protein used can be equal to or even greater than the amount of less hydrolyzed pea proteins used.

In a particular embodiment of this invention, a mixture of fully hydrolyzed and partially hydrolyzed pea proteins is used. As indicated above, fully hydrolyzed pea proteins are highly effective in promoting foaming of the egg-free albumen substitute of this invention. That being the case, in those embodiments in which a reasonable degree of foaming is desired, the amount of fully hydrolyzed pea protein used can be small relative to the amount of partially hydrolyzed pea protein used, since the foaming ability of the fully hydrolyzed pea protein is so great. On the other hand, in those embodiments of the invention in which a higher degree of foaming is desired, a greater amount of the fully hydrolyzed pea protein can be used.

Generally speaking, therefore, the amount of fully hydrolyzed protein used will be such that the weight ratio of fully hydrolyzed pea protein to partially hydrolyzed pea protein used is 1:1 to 1:30, 1:2 to 1:20, 1:3 to 1:15, 1:4 to 1:12, or even 1:5 to 1:10. This means that the weight ratio of fully hydrolyzed pea protein to partially hydrolyzed pea protein in this embodiment can be ≤1:1, ≤1:2.5, ≤1:5, ≤1:7.5, ≤1:10, ≤1:12.5, ≤1:15 or even ≤1:20 and, in addition, ≥1:25, ≥1:20, ≥1:15, ≥1:10, ≥1:5, ≥1:3, or even ≥1:2.

Proportions

The relative amounts of starch and edible gum to be include in the egg-free albumen replacement of this invention can vary widely and depends, among other things on the particular ultimate food product to be made with the inventive egg-free albumen replacement. This means that, in some embodiments of this invention, the amounts of starch and edible gum used will be roughly the same. In these embodiments, the starch/gum weight ratio can be 3:1 to 1:3 but more typically will be 2:1 to 1:2, 1.5:1 to 1:1.5, 1.25:1 to 1:1.25, or even 1.15:1 to 1:1.15.

In other embodiments, more starch than edible gum will be used. If so, the starch/gum weight ratio can be 6:1 to 1:1 but more typically will be 5:1 to 1.5:1, 4:1 to 2:1, or even 3.5:1 to 2.5:1. In still other embodiments, less starch than edible gum will be used. If so, the starch/gum weight ratio can be 1:1 to 1:6 but more typically will be 1:1.5 to 1:5, 1:2 to 1:4, or even 1:2.5 to 1:3.5.

As indicated above, it has been found in accordance with this invention that an egg-free albumen substitute mimicking naturally-occurring hen egg albumen in terms of desirable functional and organoleptic properties can be produced by adding a small but suitable amount of hydrolyzed pea protein to the starch/gum mixture described above, at least some of which is partially hydrolyzed.

To this end, the total amount of hydrolyzed pea protein in the albumen replacement of this invention, both partially hydrolyzed and fully hydrolyzed, will be normally be 3 to 75 wt. %, based on the weight of this albumen replacement as a whole—in particular, based on combined weights of the starch, edible gum and hydrolyzed pea proteins used to form this replacement. More typically, the total amount of hydrolyzed pea protein present will be 3.25 to 70 wt. %, 3.5 to 65 wt. %, 4 to 60 wt. %, 5 to 55 wt. %, 10 to 50 wt. %, or even 15 to 40 wt. %, on this basis. Thus, the total amount of hydrolyzed pea protein present can be ≤70 wt. %, ≤65 wt. %, ≤60 wt. %, ≤55 wt. %, ≤50 wt. %, ≤45 wt. %, ≤40 wt. %, ≤35 wt. %, ≤30 wt. %, ≤25 wt. %, ≤20 wt. %, ≤15 wt. %, ≤10 wt. %, or even ≤5 wt. %, on this basis, depending on the particular ultimate food product to be made with the inventive egg-free albumen replacement.

Similarly, the total amount of starch in the albumen replacement of this invention will be normally be 10 to 70 wt. %, based on the weight of this albumen replacement as a whole—in particular, based on combined weights of the starch, edible gum and hydrolyzed pea proteins used to form this replacement. More typically, the total amount of starch present will be 12.5 to 60 wt. %, 15 to 50 wt. %, 20 to 60 wt. %, 25 to 55 wt. %, or even 30 to 50 wt. %, on this basis. Thus, the total amount of starch can be ≥25 wt. %, ≥30 wt. %, ≥35 wt. %, ≥40 wt. %, ≥45 wt. %, ≥50 wt. %, ≥55 wt. %, ≥60 wt. %, ≥65 wt. %, ≥70 wt. % or more, depending on the particular ultimate food product to be made with the inventive egg-free albumen replacement. In addition, the total amount of starch can also be ≤60 wt. %, ≤55 wt. %, ≤50 wt. %, ≤40 wt. %, ≤35 wt. %, ≤30 wt. %, ≤25 wt. %, ≤20 wt. %, ≤15 wt. %, ≤10 wt. % or less, also depending on the particular ultimate food product to be made with the inventive egg-free albumen replacement.

Similarly, the total amount of edible gum in the albumen replacement of this invention will be normally be 10 to 70 wt. % based on the weight of this albumen replacement as a whole—in particular, based on combined weights of the starch, edible gum and hydrolyzed pea proteins used to form this replacement. More typically, the total amount of edible gum present will be 25 to 65 wt. %, 30 to 60 wt. %, 35 to 55 wt. %, 30 to 50 wt. %, or even 35 to 45 wt. %, on this basis. Thus, the total amount of edible gum can be ≥25 wt. %, ≥30 wt. %, ≥35 wt. %, ≥40 wt. %, ≥45 wt. %, ≥50 wt. %, ≥55 wt. %, ≥60 wt. %, ≥65 wt. %, or more, depending on the particular ultimate food product to be made with the inventive egg-free albumen replacement. In addition, the total amount of edible gum can also be ≤60 wt. %, ≤55 wt. %, ≤50 wt. %, ≤40 wt. %, ≤35 wt. %, ≤30 wt. %, ≤25 wt. %, ≤20 wt. %, ≤15 wt. %, ≤10 wt. % or less, also depending on the particular ultimate food product to be made with the inventive egg-free albumen replacement.

The inventive egg-free albumen replacement made in this way will normally be in the form of a dry powder resembling dehydrated albumen in consistency and color. And just like dehydrated albumen, this egg-free albumen replacement can be reconstituted into a liquid albumen analog (the “albumen substitute” of this invention) by combining with a suitable amount of water. And in the same way as naturally-occurring albumen, other edible aqueous liquids such as milk, cream, almond milk, etc. can also be used for this purpose, in addition to water.

The amount of water or other aqueous liquid used for converting the dry powder albumen replacement of this invention into the inventive liquid albumen substitute will be essentially the same as that used to reconstitute commercially available dehydrated albumen, i.e., about 20 to 1 on a weight basis. That is, the amount used will be about 20 times as much, on a weight basis, as the combined weights of the starch, edible gum and hydrolyzed pea proteins which form the inventive egg-free albumen replacement. Greater or lesser amounts of water or other aqueous liquid can be used to produce egg-free albumen substitutes of this invention with greater or lesser viscosities and ingredient concentrations, as desired.

### Acidifiers

In addition to the above ingredients, the inventive albumen replacement can also include additional optional ingredients for helping to improve the rheological properties, storage stability, mold resistance and other properties of this replacement and/or ultimate food products made with it.

For example, the inventive albumen replacement can include acidifiers to achieve a desirable pH in the food products being made. Examples include acetic acid, fumaric acid, lactic acid, phosphoric acid, malic acid, tartaric acid, citric acid, succinic acid, sodium and/or potassium salts of any of the foregoing acids, cream of tartar (potassium hydrogen salt of tartaric acid) and sodium acid pyrophosphate. Naturally-occurring food products containing these acids and/or salts such as lemon juice, vinegar, etc. can also be used. Acidifiers can be beneficial especially in the case of egg-free meringues, since a lower pH can help stabilize the meringue foam against collapsing and prevent mold growth. Tartaric acid and sodium acid pyrophosphate, and especially mixtures of tartaric acid and sodium acid pyrophosphate, are preferred for this application.

The amount of acidifier used can vary widely and depends among other things on the effect being sought as well as the acid strength of the particular acidifier used. For example, a lower pH is known to improve meringue body and firmness, while also promoting a bitter taste. That being the case, when a particular acidifier is included in an inventive egg-free albumen replacement intended for making a meringue, the amount of that acidifier used should be enough to achieve a noticeable improvement in meringue body/firmness but not so much as to introduce a bitter taste.

Generally speaking, then, and considering the acid strength of the particular acidifier used, the amount of acidifier can be as little as 1 wt. % or less and as much as 25 wt. % or more, based on the weight of the inventive albumen replacement as a whole—in particular, based on combined weights of the starch, edible gum and hydrolyzed pea proteins used to form this replacement. In those instances in which particular acidifier used is relatively weak in acid strength, the total amount of acidifier used can be 2 to 22 wt. %, 4 to 20 wt. %, 6 to 18 wt. %, or even 8 to 16 wt. %, on this basis. In those instances in which particular acidifier used is stronger, the total amount of acidifier used will normally be less, for example, 1 to 10 wt. %, 1.5 to 8 wt. %, 2 to 6 wt. %, or even 3 to 5 wt. %, on this basis.

### Salt

Still another optional ingredient that can be included in the inventive egg-free albumen replacement is salt, in particular sodium chloride.

Any type of food grade sodium chloride can be used for this purpose including common table salt, Kosher salt and sea salt, for example.

The majority of pea proteins are globulins while the majority of proteins found in albumen are albumins. Relative to albumins, globulins exhibit better solubility if the water has a higher salt content. Therefore, it may be desirable at least in some embodiments of this invention to add a small amount of salt to the inventive egg-free albumen replacement to help its hydrolyzed pea protein readily dissolve when this replacement is later combined with water or other aqueous liquid.

For example, the foaming properties of meringues are known to depend, among other things, on the water solubility of the proteins from which they are made. Therefore, increasing the amount of salt used to make the inventive egg-free albumen replacement should result in better foaming properties of meringues made with this product. In addition, increasing the amount of salt used should also result in a better microbial shelf life, since salt is also known to retard mold growth.

In this regard, it has been found that the microbial shelf life of meringues made with the egg-free albumen replacement of this invention (i.e., their ability to prevent mold growth) can be extended when using higher than normal levels of salt.

The amount of salt added can vary widely and depends, among other things on the ultimate food product to be made. Of course, the amount of salt used cannot be so much that this ultimate food product tastes too salty. In addition, if more than normal amounts are used, i.e., more than would be used if the ultimate food product to be produced were being made from naturally-occurring albumen, enough salt should be used to achieve a noticeable improvement in properties in this ultimate food product. Within these broad guidelines, the amount of salt added can be as little as 1 wt. % or less and as much as 8 wt. % or more based on the weight of the inventive albumen replacement as a whole—in particular, based on combined weights of all the starch, edible gum and hydrolyzed pea proteins used to form this replacement. More typically, the total amount of acidifier used will be 2 to 5 wt. %, 2.5 to 4 wt. %, or even 3 to 3.5 wt. %, on this basis.

### Conventional Food Additives

The inventive albumen replacement can be used to make any ultimate food product that can be made with naturally-occurring hen egg albumen.

For this purpose, the inventive albumen replacement can be combined with a variety of different conventional food additives including flour, leavening agents such as baking powder and baking soda, fats and oils such as butter, margarine and vegetable oil, preservatives, and various different types of flavoring agents such as cane sugar, spices such as nutmeg and cinnamon, pepper, thyme, oregano, etc., fruit and berry products such as peaches, apples, blueberries raspberries, jams and jellies made from these fruit and berry products, orange and lemon zests, extracts such as vanilla bean extract, various liquids such as lemon juice, orange juice and vinegar, and the like.

A particular advantage of the inventive egg-free albumen replacement is that it resembles commercially available dehydrated albumen in that it can be formulated, shipped and stored in the form of a dry powder which, when combined with a suitable amount of water or other aqueous liquid, can be transformed into a liquid egg-free substitute resembling naturally-occurring hen egg albumen. Therefore, like commercially available dehydrated albumen, it can also be combined with other conventional food additives such as flour, sugar and other flavoring agents to make dry powder mixes for forming ultimate food products after combining with water or other edible aqueous liquid and appropriate processing.

For example, a meringue dry mix which can be formulated, shipped and stored in the form of a dry powder and then converted into an egg-free high-quality meringue by mixing with water and whipping can be made by combining the egg-free albumen replacement of this invention with a suitable amount of sugar. For this purpose, conventional baker's sugar (super fine) can be used as can normal cane sugar, beet sugar and processed sugars such as dextrose, fructose and glucose. Mixtures of these sugars can also be used. If so, the amount of sugar used will generally be between 80 and 220 wt. %, based on the weight of the inventive albumen replacement as a whole—in particular, based on combined weights of the starch, gum and pea proteins used to form this replacement. More typically, the amount used will be 100 to 200 wt. %, 120 to 180 wt. %, or even 135 to 150 wt. %, on this basis.

Such a meringue-forming dry mix can also contain additional flavoring agents, if desired. For example, vanilla, cinnamon and/or nutmeg can also be included to add additional flavors to the egg-free meringue obtained. The total amount of these additional flavoring agents added can be as much as 10 wt. % or more and as little as 1 wt. % or less, again based on the weight of the inventive albumen replacement as a whole—in particular, based on the combined weights of all of the starch, gum and pea proteins used to form this replacement. More typically, the amount used will be 1.5 to 8 wt. %, 2 to 6 wt. %, or even 3 to 5 wt. %, on this basis.

In accordance with embodiments of the present disclosure, an egg-free albumen replacement composition can be formed in accordance with the formulation disclosed in Table 1:

TABLE 1

| Ingredients | Weight Percent |
|---|---|
| Sugar | 25-40 |
| Dextrose | 20-30 |
| Pea Starch | 10-20 |
| Hydrolyzed Pea Protein | 10-20 |
| Xanthan Gum | 5-10 |
| Carob Bean Gum | 5-10 |
| Sodium Acid Pyrophosphate | 1-5 |
| Cream of Tartar | 1-5 |
| Salt | 1-5 |
| Vinegar Powder | 0-2 |
| Guar Gum | 0-1 |
| Fumaric Acid | 0-1 |
| Natural Flavor | 0-1 |

In the same way, dry mixes for making a variety of different ultimate food products such as cookies, cakes, breads, pastas, frostings, other gluten-free baked products, chewy candies and the like can also be made using this approach.

These dry mixes can then be converted into ultimate food products by appropriate processing—i.e., by treating the dry mix in the same way that a corresponding mixture of conventional ingredients for making the same ultimate food product would be treated. For example, if a conventional dry mix for making a particular cake called for the addition of 250 ml of water to make a batter followed by baking the batter in an oven at 175° C. for 30 minutes, then the corresponding dry mix of this invention, i.e., a dry mix formulated for making the same cake but containing the inventive egg-free albumen replacement instead of dehydrated albumen, would be processed in the same way.

In accordance with embodiments of the present invention, a “wet meringue” composition can be formed. In embodiments, the wet meringue can be produced using the egg-free albumen replacement composition, sugar (e.g., bakers special sugar), and water. The egg-free albumen replacement composition and the sugar can be mixed, and then added to hot water (e.g., water at a temperature of 140° F.). The mixture can be mixed and/or whipped at a variety of speeds. In various embodiments, the components can be mixed at two separate speeds. The mixed components can then be broiled using, for example, a conventional oven or a torch.

In various embodiments, the wet meringue composition can be formed using the components in Table 2:

TABLE 2

| Ingredients | Amount (g) |
|---|---|
| Egg-free albumen replacement composition | 31 |
| according to the present disclosure | |
| Bakers Special Sugar | 139 |
| Hot Water (140° F.) | 220 |

In addition to making ultimate food products from dry mixes as described above, the egg-free albumen replacement composition according to the present disclosure can be used to make ultimate food products which are liquids at room temperatures, examples of which include various beverages including mochas, milk shakes, chocolate milk, buttermilk, eggnog, etc., as well as ultimate food products which are made by chilling and/or freezing such liquid food products such as ice cream, sherbet, sorbets, etc.

Although only a few embodiments of the invention have been described above, it should be appreciated that many modifications can be made without departing from the spirit and scope of the invention. For example, although the protein content of the egg-free albumen replacement composition according to the present disclosure is based on hydrolyzed pea protein, other types of protein such as native pea protein as well as native and hydrolyzed proteins derived from various other plant and animal sources such as soy, rice, quinoa, lentils, chickpeas, peanut, chia seeds, whey, fish, etc. can also be present. If so, the total amount of this other type of protein present should be ≤30 wt. %, preferably ≤20 wt. %, ≤10 wt. %, ≤5 wt. %, or even ≤2 wt. %, based on the total amount of protein present. All such modifications are intended to be included within the scope of this invention, which is to be limited only by the following claims:

1. An egg-free albumen replacement composition comprising
a starch;
an edible gum; and
a hydrolyzed pea protein in an amount of 3 to 75 wt. %, based on the combined weights of the starch, edible gum and hydrolyzed pea protein in the replacement composition,
wherein at least some of the hydrolyzed pea protein comprises partially hydrolyzed pea protein.

2. The egg-free albumen replacement composition of claim 1, wherein the egg-free albumen replacement composition comprises 5 to 55 wt. % hydrolyzed pea protein, based on the combined weights of the starch, edible gum and hydrolyzed pea protein in the replacement composition.

3. The egg-free albumen replacement composition of claim 1, wherein the hydrolyzed protein comprises at least two different hydrolyzed pea proteins, one of which has a greater degree of hydrolysis (DH) and the other of which has a lesser degree of hydrolysis (DH).

4. The egg-free albumen replacement of claim 3, wherein the average DH of the hydrolyzed protein with the greater degree of hydrolysis is at least 4 percentage points greater than the DH of the hydrolyzed protein with the lesser degree of hydrolysis.

5. The egg-free albumen replacement of claim 3, wherein the average DH of the hydrolyzed protein with the greater degree of hydrolysis is at least 7 percentage points greater than the DH of the hydrolyzed protein with the lesser degree of hydrolysis.

6. The egg-free albumen replacement composition of claim 1, wherein the hydrolyzed pea protein comprises partially hydrolyzed pea protein and fully hydrolyzed pea protein.

7. The egg-free albumen replacement composition of claim 1, wherein the weight ratio of the starch to the edible gum is 2:1 to 1:2.

8. The egg-free albumen replacement composition of claim 1, wherein at least 85 wt. % of the starch comprises one or more native starches.

9. The egg-free albumen replacement composition of claim 1, wherein the starch comprises pea starch.

10. The egg-free albumen replacement composition of claim 1, wherein the edible gum comprises one or more of xanthan gum, locust bean gum and guar gum.

11. The egg-free albumen replacement composition of claim 1, wherein the edible gum comprises a mixture of two or more of xanthan gum, locust bean gum and guar gum.

12. The egg-free albumen replacement composition of claim 1, further comprising an acidifier.

13. The egg-free albumen replacement composition of claim 12, wherein the acidifier is cream of tartar, sodium acid pyrophosphate or a mixture thereof.

14. The egg-free albumen replacement composition of claim 12, wherein the amount of acidifier in the egg-free albumen replacement is sufficient so that the pH of the egg-free albumen substitute produced by combining the egg-free albumen replacement with water is 3.0 to 6.5.

15. The egg-free albumen replacement composition of claim 1, further comprising sodium chloride in an amount of 2 to 5 wt. %, based on combined weights of the starch, the edible gum and the hydrolyzed pea protein in the composition.

16. The egg-free albumen replacement composition of claim 1, wherein the composition is in the form of a dry powder.

17. A liquid egg-free albumen substitute comprising the egg-free albumen replacement composition of claim 1 plus an edible aqueous liquid.

18. A dry powder mix for forming into an ultimate food product, the dry powder mix comprising the egg-free albumen replacement composition of claim 1 plus one or more additional food additives.

19. The dry powder mix of claim 18, wherein the one or more additional food additives comprises one or more of flour, sugar, and other flavoring agents.

20. A dry powder mix capable of forming an egg-free meringue when combined with water and whipped, the dry powder mix comprising sugar and the egg-free albumen replacement composition of claim 1.

21. The dry powder mix of claim 20, further comprising vanilla.

22. A food product comprising the material obtained by combining at least one of flour, sugar, one or more flavoring agents and an optional aqueous liquid with the egg-free albumen replacement of claim 1 followed by processing the mixture so formed into the food product by one or more of mixing, beating, whipping, baking, chilling and freezing.
